(19) United States
(12) Patent Application Publication
(10) Pub. No.: US 2019/0188647 A1
(43) Pub. Date: Jun. 20, 2019

(54) MULTIPLE ELEMENT JOB CLASSIFICATION

(71) Applicant: SAP France, Mougins (FR)

(72) Inventors: Jean-Baptiste Gariel, Paris (FR); Marc Vu, Paris (FR); Marwan Ajala, Paris (FR)

(21) Appl. No.: 15/842,443

(22) Filed: Dec. 14, 2017

(51) Int. Cl. G06Q 10/10; G06Q 10/06; G06F 17/30

(52) U.S. Cl. CPC G06Q 10/1053; G06F 17/30876; G06F 17/30864; G06Q 10/063112

(57) ABSTRACT

Multiple element job classification data objects include values for multiple elements related to a job. The multiple element job classification data object may be generated automatically from a job listing or search query. A database of multiple element job classification data objects may be created using scraping. Scraping job listing data from multiple job listing sites allows for the creation of a centralized database that includes all job listings from the multiple sites. Converting the job listings from a typical title-and-description format into multiple element job classification data objects permits more accurate searching of the data. The database of multiple element job classification data objects may be searched for relevant job listings by a user who provides a text string. The text string is converted into a multiple element job classification data object and used to find job listings that correspond to the user's search.

### TECHNICAL FIELD

The subject matter disclosed herein generally relates to methods and systems for classifying jobs. Specifically, the present disclosure addresses systems and methods to generate and use a multiple element job classification.

### BACKGROUND

Existing job classification systems are built by human experts. The job classification systems each include a set of job classifications, with each job classification including a title of a job. Example job classification systems include O*NET and ROME. The job classification systems are manually updated annually or semi-annually to include new job classifications.

### BRIEF DESCRIPTION OF THE DRAWINGS

Some embodiments are illustrated by way of example and not limitation in the figures of the accompanying drawings.

FIG. 1 is a network diagram illustrating a network environment suitable for implementing multiple element job classification, according to some example embodiments.

FIG. 2 is a block diagram of a search server, according to some example embodiments, suitable for implementing multiple element job classification.

FIG. 3 is a block diagram illustrating a database schema suitable for implementing multiple element job classification, according to some example embodiments.

FIG. 4 is a flowchart illustrating operations of a method suitable for generating a multiple element job classification data object, according to some example embodiments.

FIG. 5 is a flowchart illustrating operations of a method suitable for determining a category for use in a multiple element, job classification data object, according to some example embodiments.

FIG. 6 is a flowchart illustrating operations of a method suitable for categorizing tokens of a job listing, according to some example embodiments.

FIG. 7 is a flowchart illustrating operations of a method suitable for causing presentation of multiple element job classification data object data in response to a job title, according to some example embodiments.

FIGS. 8-9 are a flowchart illustrating operations of a method suitable for training a machine-learning algorithm, storing multiple element job classification data objects in a database, and causing presentation of job listings in response to a search query, according to some example embodiments.

FIG. 10 is a screen diagram illustrating a user interface suitable for displaying search results, according to some example embodiments.

FIG 11 is a block diagram illustrating components of a machine, according to some example embodiments.

### DETAILED DESCRIPTION

Example methods and systems are directed to the generation and use of multiple element job classifications. Multiple element job classification data objects include values for multiple elements related to the job. For example, a multiple element job classification data object may include data representing a title, a language, one or more skills, a level of experience, or any suitable combination thereof. The multiple element job classification data object may be generated automatically from a job listing or search query.

A database of multiple element job classification data objects may be created using scraping. Scraping is the process of automatically retrieving documents and extracting information from the documents. For example, a web scraper may periodically visit a number of predefined web sites, retrieve web pages from those web sites, and extract information added to the web sites since the last visit. Scraping job listing data from multiple job listing sites allows for the creation of a centralized database that includes all job listings from the multiple sites. Converting the job listings from a typical title-and-description format into multiple element job classification data objects permits more accurate searching of the data.

The database of multiple element job classification data objects may be searched for relevant job listings by a user who provides a text string. The text string is converted into a multiple element job classification data object and used to find job listings that correspond to the user's search. A user interface may be provided to the user that displays data from the resulting multiple element job classification data objects, data from the job listings used to generate the resulting multiple element job classification data objects, or any suitable combination thereof.

When these effects are considered in aggregate, one or more of the methodologies described herein may obviate a need for certain efforts or resources that otherwise would be involved in categorizing or searching for job listings. Computing resources used by one or more machines, databases, or may similarly be reduced. Examples of such computing resources include processor cycles, network traffic, memory usage, data storage capacity, power consumption, and cooling capacity.

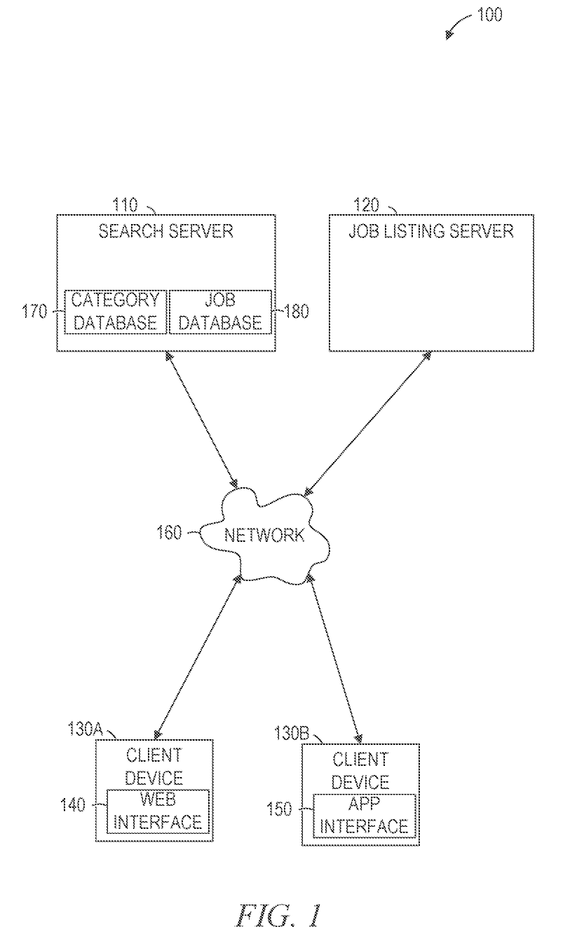

FIG. 1 is a network diagram illustrating a network environment 100 suitable for implementing multiple element job classification, according to some example embodiments. The network environment 100 includes a search server 110, a job listing server 120, client devices 130A and 130B, and a network 160. The search server 110 provides a search application to the client devices 130A and 130B via a web interface 140 or an application interface 150. The category database 170 (e.g., a first database) and the job database 180 (e.g., a second database) are shown as being part of the search server 110, but may be served by a database server instead.

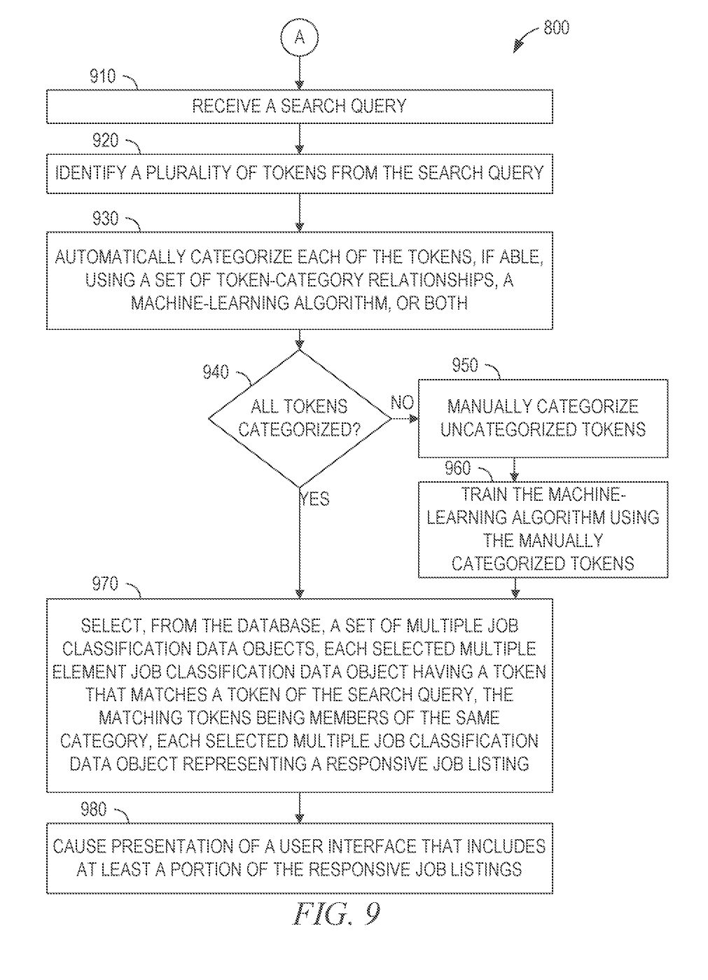

In some example embodiments, the search server 110 scrapes data from the job listing server 120 to populate the job database 180. The client device 130A allows a user to interact with the search application through the web interface 140. The client device 130B allows a user to interact with the search application through the application interface 150. The search server 110, the job listing server 120, and the client devices 130A and 130B may each be implemented in a computer system, in whole or in part, as described below with respect to FIG. 9.

The search server 110 may receive search query from a client device 130 and, using the category database 170, categorizes tokens of the search query to generate a multiple element job classification corresponding to the query, with a value for one or more of the categories. Based on the generated multiple element job classification, the search server 110 determines responsive elements in the job database 180 and provides at least a subset of the responsive elements to the client device 130.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The search server 110, the job listing server 120, and the client devices 130A-130B may be connected by the network 160. The network 160 may be any network that enables communication between or among machines, databases, and devices. Accordingly, the network 160 may be a wired network, a wireless network (e.g., a mobile or cellular network), or any suitable combination thereof. The network 160 may include one or more portions that constitute a private network, a public network (e.g., the Internet), or any suitable combination thereof.

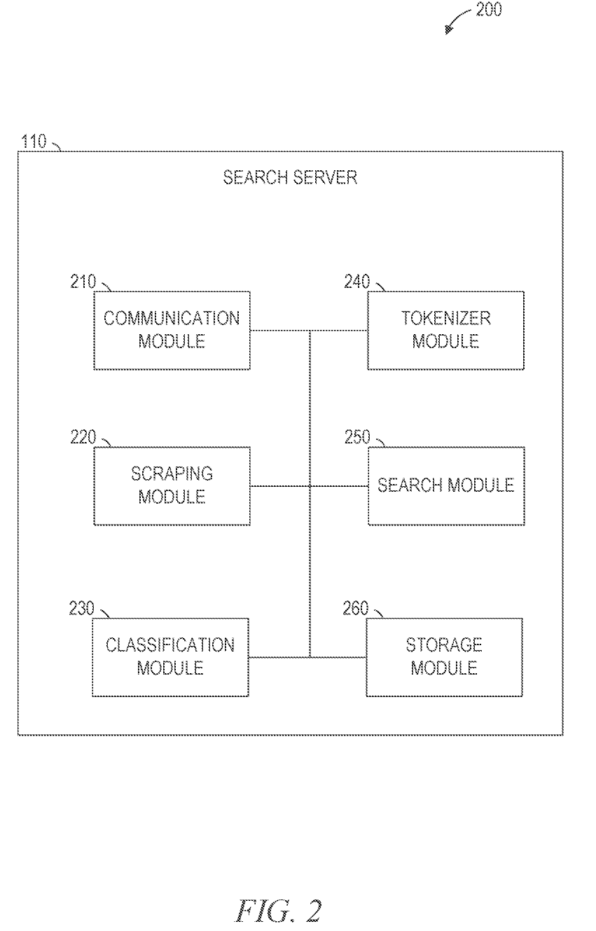

FIG. 2 is a block diagram 200 illustrating components of the search server 110, according to some example embodiments. The search server 110 is shown as including a communication nodule 210, a scraping module 220, a classification module 230, a tokenizer module 240, a search module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine database, or device may be distributed across multiple machines, databases, or devices.

The communication module 210 receives data sent to the search server 110 and transmits data from the search server 110. For example, the communication module 210 may receive, from the client device 130A, a query comprised of a text string. In some example embodiments, the query includes a second datum indicating a locale for the query. The locale may correspond to a language of the text string and be used during token categorization. The communication module 210 may provide the query to the tokenizer module 240, which divides the query into tokens, and provides the tokens to the classification module 230 to classify the tokens and generate a multiple element job classification data object. The classification module 230 provides the multiple element job classification data object to the search module 250. The search module 250 searches a database via the storage module 260 to identify multiple element job classification data objects responsive to the query. The communication module 210 may transmit the responsive data to the client device 130A. Communications sent and received by the communication module 210 may be intermediated by the network 160.

The scraping module 220 accesses, via the communication module 210, documents that contain data to be searched. For example, the scraping module 220 may periodically access web sites of a predefined list of web sites to identify job listings added since the last access. Each job listing may be processed by the tokenizer module 240 to identify tokens, and the tokens may be processed by the classification module 230 to generate a multiple element job listing data object. In some example embodiments, the generated multiple element job listing data object is presented to an administrator for validation and used for further processing or storage only after being validated by the administrator. The scraping module 220 may, via the storage module 260, add the generated multiple element job listing data object to a database. The storage module 260 accesses the data in the database. For example, a scraping table, a multiple element job listing table, or any suitable combination thereof may be stored by the storage module 260.

As discussed above, the tokenizer module 240 identifies tokens from a string. For example, a text string may include multiple words separated by whitespace (e.g., spaces, tabs, carriage returns, and other non-visible characters). Using the whitespace as a separator, each word may become a token. In some example embodiments, tokens may comprise multiple words. For example, a database of known phrases ma be checked to determine if multiple words should be treated as a single token. For words that could be handled as part of multiple phrases, longer phrases may be preferred. For example, “software engineer” may be treated as a single token instead of one token for “software” and one for “engineer,” based on the phrase “software engineer” appearing in the phrase database. The phrase “deep sea diver” may be treated as a single token instead of one token for “deep” and one for “sea diver,” even if both “deep sea diver” and “sea diver” appear in the phrase database, due to the longer phrase being found.

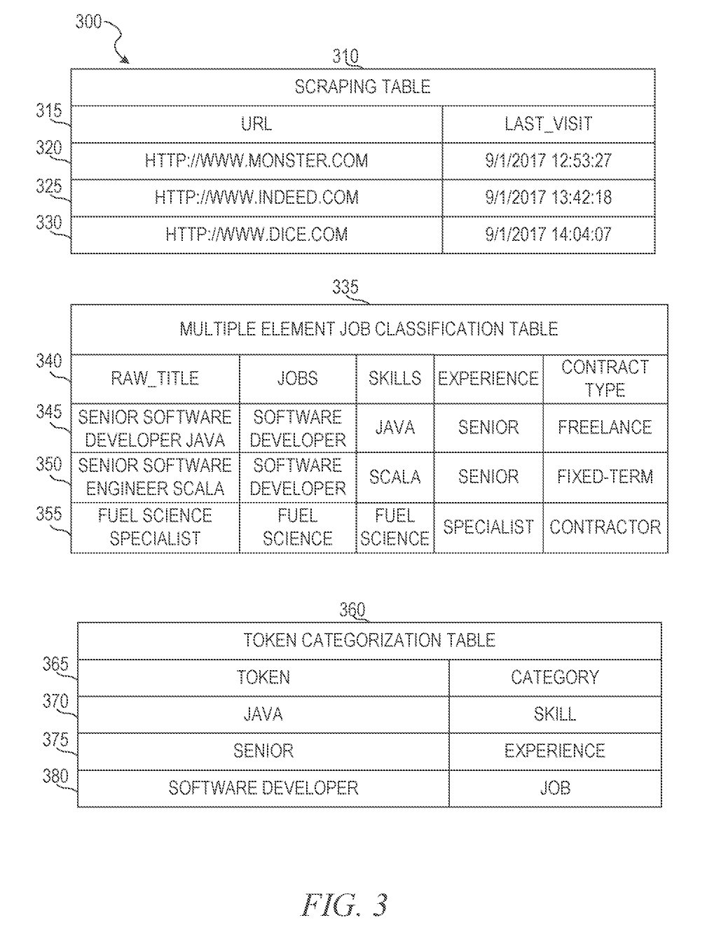

FIG. 3 is a block diagram illustrating a database schema 300 suitable for implementing multiple element job classification, according to some example embodiments. The database schema 300 includes a scraping table 310, a multiple element job classification table 335, and a token categorization table 360. The scraping table 310 has rows 320, 325, and 330 of a format 315. The multiple element job classification table 335 stores multiple element job classification objects and has rows 345, 350, and 355 of a format 340. Tables of the database schema 300 may be stored in one database or multiple databases. For example, the multiple element job classification table 335 may be part of the job database 180 while the token categorization table 360 may be part of the category database 170.

The format 315 of the scraping table 310 includes a uniform resource locator (URL) field and a last visit field. Accordingly, each of the rows 320-330 identifies a URL and a timestamp of the last visit to the URL.

The format 340 of the multiple element job classification table 335 includes a raw title field, a jobs field, a skills field, an experience field, and a contract type field. The raw title field contains the raw title of a job listing. Each of the other fields contains one or more identifiers of the type of the field. For example, the jobs field contains one or more job identifiers and the skills field contains one or more skill identifiers. In some example embodiments, jobs are organized in a hierarchy. Thus, additional fields may be added to the multiple element job classification table 335 such as a job family field (e.g., “Engineering”) containing a single job family and a job super title field (e.g., “Software Developer”) containing a single job super title, in addition to the jobs field (e.g., “software developer,” “developer”) containing one or more job titles.

The format 340 of the multiple element job classification table 335 is provided by way of example only, and the multiple element job classification table 335 may contain more or fewer fields. For example, a hierarchy field that indicates the position of the job in a company hierarchy (e.g., manager, lead, chief, director, team leader, vice president, and the like) may be included. Fields of the job classification table 335 may correspond to categories of the token categorization table 360. Thus, rows in the table 335 may define values for categories. For example, the row 345 defines a value of “Software Developer” for the category of “Job,” a value of “Java” for the category of “Skill,” a value of “Senior” for the category of “Experience,” and a value of “Freelance” for the category of “Contract Type.” In some example embodiments, one or more values may be null, indicating that the multiple element job classification object represented by the row has no value for the corresponding category.

The token categorization table 360 relates known tokens to their categories. The format 365 of the token categorization table 360 includes a token field and a category field. The rows 370-380 each relate a token to a category. Thus, “Java” is a member of the “Skill” category (row 370), “Senior” is a member of the “Experience” category (row 375), and “Software Developer” is a member of the “Job” category (row 380). In some example embodiments, multiple rows may exist for a single token, indicating that the token is a member of multiple categories. For example, the token “Chef” may be categorized as an Information Technology skill (referring to the software language), as a job title (referring to a restaurant employee), and as a hierarchy position (in French). The token categorization table 360 may include a locale field that indicates one or more locales for which the token-to-category mapping is valid. For example, “Chef” may be a hierarchy position only for the France or Quebec locales, an IT skill for all locales, and a job title for CTS, UK, France, and Canada locales.

Categorizations may be supplemented with synonyms. For example, aliases may be generated for some terms. Thus, “software engineer” and “software developer” may be classified not only as both being job titles, but as being titles for the same job, as shown in the rows 345 and 350. Aliases may be provided by an administrator or generated automatically by a machine-learning algorithm. Similarly, terms in different languages that have the same meanings may be treated as synonyms. For example, “Software Engineer” and “Ingénieur logicier” may be treated as synonyms.

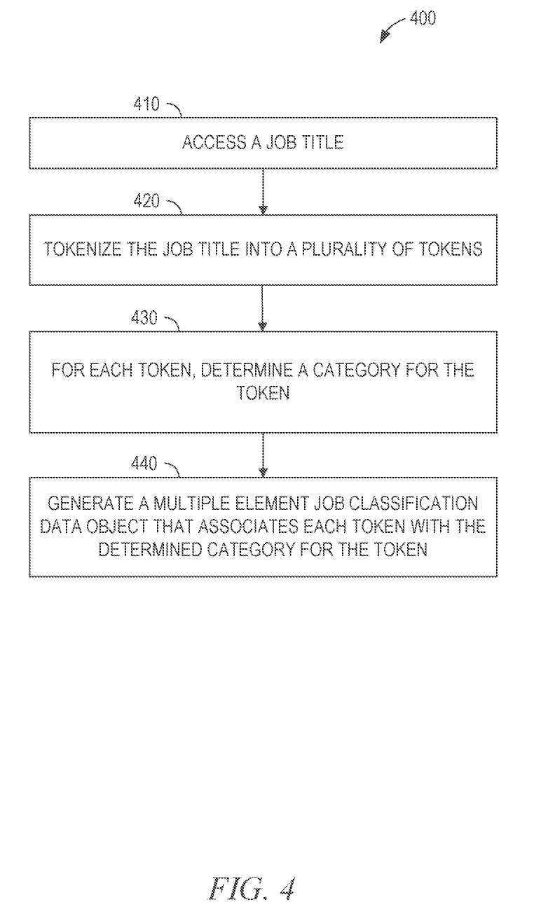

FIG. 4 is a flowchart illustrating operations of a method 400 suitable for generating a multiple element job classification data object, according to some example embodiments. The method 400 includes operations 410, 420, 430, and 440. By way of example and not limitation, the method 400 is described as being performed by the devices, modules, and databases of FIGS. 1-3. By way of example, the operations of the method 400 are described as operating on a job title. However, other text strings may also be used.

The tokenizer module 240 accesses, in operation 410, a job title. The job title may have been provided by a user searching for a job, via the search module 250. Alternatively, the job title may have been retrieved by the scraping module 220 from a job listing document (e.g., a web page).

In operation 420, the tokenizer module 240 tokenizes the job title into a plurality of tokens. In some example embodiments, prior to being tokenized, the job title is normalized. Normalizing the job title removes elements of the job title that lack semantic meaning. For example, each character in the job title may be converted to uppercase, each character in the job title may be converted to lowercase, emphasis in the job title (e.g., italics, bold, or underlining) may be removed, special characters (e.g., non-alphabetic characters, non-alphanumeric characters, non-displaying characters, punctuation characters, or any suitable combination thereof) may be removed, or any combination thereof. Additionally or alternatively, words in the job title may be removed or changed during normalization. For example, any words appearing in a predetermined list of words (e.g., “and,” “or,” or “the”) may be removed from the job title.

For each token, the classification module 230 determines a category for the token (operation 430). Example categories include title, experience level, skill, language, and job. In some example embodiments, a list of tokens belonging to each category is accessed by the classification module 230 to determine if the token matches a token in the category. If a match is found, the matching category is assigned to the token. Word stemming may also be used on the token. Word stemming removes prefixes, suffixes, or both from a word to yield a root word. For example, “unreasonable” may become “reason” after word stemming. As another example, “hostess” may become “host” and, in French, “Boulanger” may become “Boulangere.”

In operation 440, the classification module 230 generates a multiple element job classification data object that associates each token with the determined category for the token. The multiple element job classification data object may be stored in a database table (e.g., the multiple element job classification table 335).

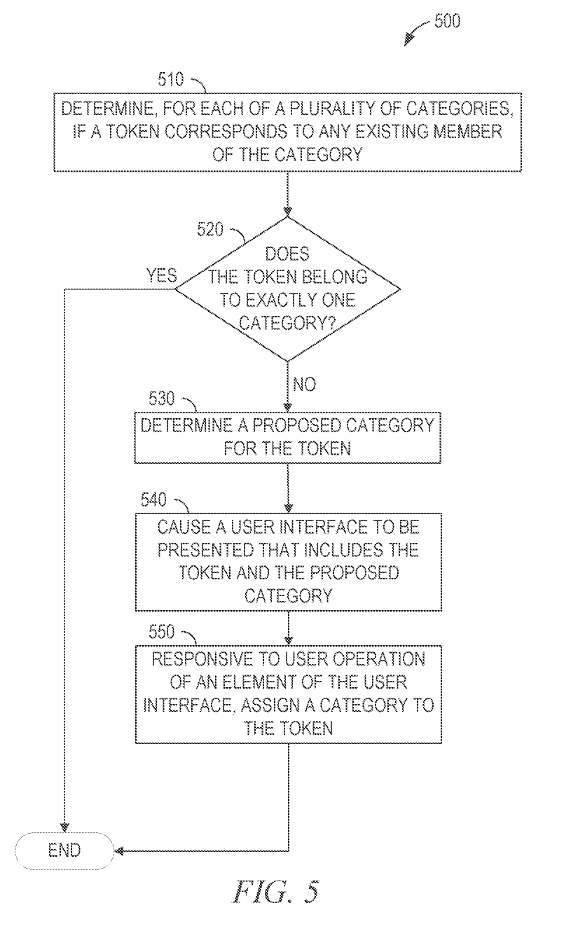

FIG. 5 is a flowchart illustrating operations of a method 500 suitable for determining a category for use in a multiple element job classification data object, according to some example embodiments. The method 500 includes operations 510, 520, 530, 540, and 550. By way of example and not limitation, the method 500 is described as being performed by the devices, modules, and databases of FIGS. 1-3. The method 500 may be used to perform operation 430 of the method 400.

In operation 510, the classification module 230 determines, for each of a plurality of categories, if a token corresponds to any existing member of the category. For example, the token may be used in a database query of the token categorization table 360 to determine if the token corresponds to an existing member of the category. Each row returned by the database query indicates a matching category for the token. For example, the token “Java” is an existing member of the category “Skill” as indicated by the row 370 of the categorization table 360.

The classification module 230 determines, in operation 520, if the token belongs to exactly one category. If so, the method 500 terminates and the category for the token has been found. Otherwise, the method 500 proceeds with operation 530.

In operation 530, the classification module 230 determines a proposed category for the token. The proposed category may be the category having a greatest probability that the token belongs as determined by a machine-learning algorithm. In some example embodiments, the proposed category is selected using a conditional random field (CRF) algorithm trained on specific objects. For example, a CRF may be trained on job titles annotated with specific categories (job, skill, hierarchy, and contract type, for example). The output of the CRF may be a probability of belonging to a specific category for each token of the job title.

The classification module 230 causes, in operation 540, a user interface to be presented that includes the token and the proposed category. For example, a user interface may be presented on the client device 130A via the web interface 140 using a web page supplied by the search server 110. In some example embodiments, the user interface includes a drop-down selector that allows the user to select a category for the token.

In response to user operation of an element of the user interface, the classification module 230 assigns a category to the token (operation 550). For example, the category selected by the user may be assigned to the token. The category selected by the user may be an alternative category (i.e., a category other than the proposed category). As another example, the user interface presented in operation 540 may include a button operable to confirm the proposed category and, in operation 550, in response to user operation of the button, the proposed category may be assigned to the token.

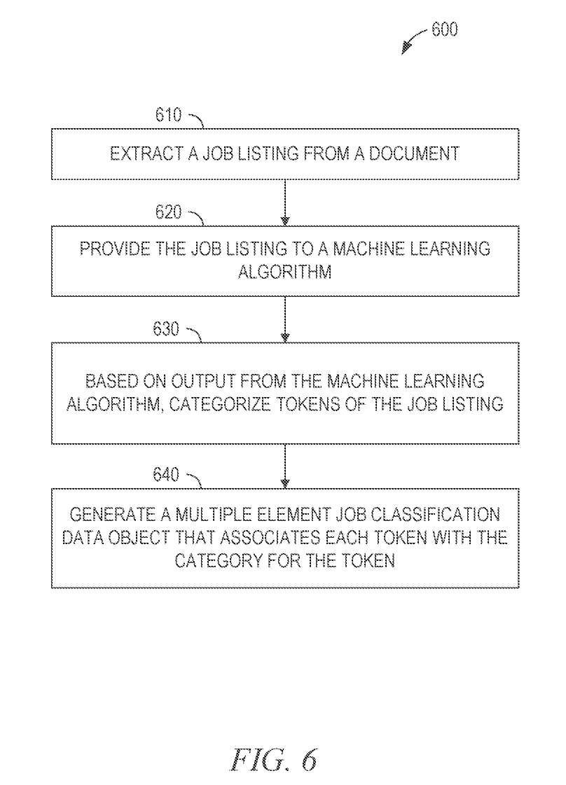

FIG. 6 is a flowchart illustrating operations of a method 600 suitable for categorizing tokens of a job listing, according to some example embodiments. The method 600 includes operations 610, 620, 630, and 640. By way of example and not limitation, the method 600 is described as being performed by the devices, modules, and databases of FIGS. 1-3.

The scraping module 220 extracts a job listing from a document, in operation 610. For example, the scraping module 220 may periodically access web sites of a predefined list of web sites stored in the scraping table 310. After retrieving a copy of the web site, the scraping module 220 parses the web site to identify job listings (e.g., job listings that include titles).

In operation 620, the scraping module 220 provides the job listing to a machine learning algorithm (e.g., of the classification module 230). The machine learning algorithm may have been trained on a training set of words to correctly categorize the words. In response to receiving the job listing, the machine learning algorithm may provide a category for each word in the job listing or each word in the title of the job listing.

The classification module 230, in operation 630, categorizes tokens of the job listing based on output from the machine learning algorithm. In operation 640, the classification module 230 generates a multiple element job classification data object that associates each token with the category for the token. The multiple element job classification data object may be stored in a database table (e.g., the multiple element job classification table 335). In some example embodiments, a named entity recognition (NER) algorithm is used (e.g., the Stanford NER). The NER may determine a meaning for each word in a phrase. The meaning for each word may be based on the word itself, the previous word, the following word, the position of the word within the phrase (e.g., at the beginning of the phrase or the end of the phrase), components of the word (e.g., prefix, suffix, and root), or any suitable combination thereof. For example, if the first word of the phrase ends with the suffix-ior senior or junior), the first word may be determined to be in an experience level category.

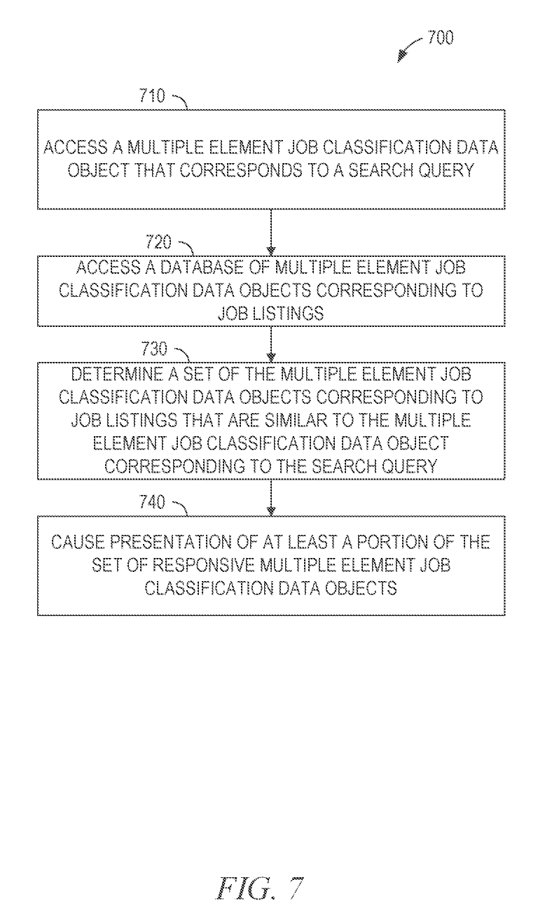

FIG. 7 is a flowchart illustrating operations of a method 700 suitable for causing presentation of multiple element job classification data object data in response to a job title, according to some example embodiments. The method 700 includes operations 710, 720, 730, and 740. By way of example and not limitation, the method 700 is described as being performed by the devices, modules, and databases of FIGS. 1-3.

In operation 710, the search module 250 accesses a first multiple element job classification data object that corresponds to a search query. The first multiple element job classification data object may have been generated from a text string provided by a user searching for a job, using the method 400.

The search module 250, in operation 720, accesses a database of multiple element job classification data objects corresponding to job listings and, in operation 730, determines a set of the multiple element job classification data objects corresponding to job listings that are similar to the multiple element job classification data object corresponding to the search query. For example, a SQL query such as “SELECT” from MultipleElementJobClassification WHERE raw_title=first.raw_title AND jobs=first.jobs AND skill s=first.skills AND experience=first.experience” may be run against the multiple element job classification table 335 to identify rows in the table that exactly match the first multiple element job classification data object. In some example embodiments, partial matches are identified in addition to or instead of exact matches. For example, the first multiple element job classification data object may include multiple skills, and gored multiple element job classification data objects may be considered to match the skill element if they include any of the skills of the first multiple element job classification data object.

In operation 740, the search module 250 causes presentation of at least a portion of the set of responsive multiple element job classification data objects. For example, a web page including a list of the raw title fields of the first ten responsive multiple element job classification data objects may be presented to the user via the web interface 140 of the client device 130A. In some example embodiments, the original job listing is presented instead of or in addition to the raw title field for each of the responsive multiple element job classification data objects. For example, the multiple element job classification table 335 may include an additional field that indicates a source for the job listing (e.g., a URL of a job listing site that is specific to the job listing, such as http://job-openings.monster.com/11/189254017). The content of the job listing may be embedded in the user interface, the raw title field may be presented as a hyperlink that links to the job listing, or any suitable combination thereof.

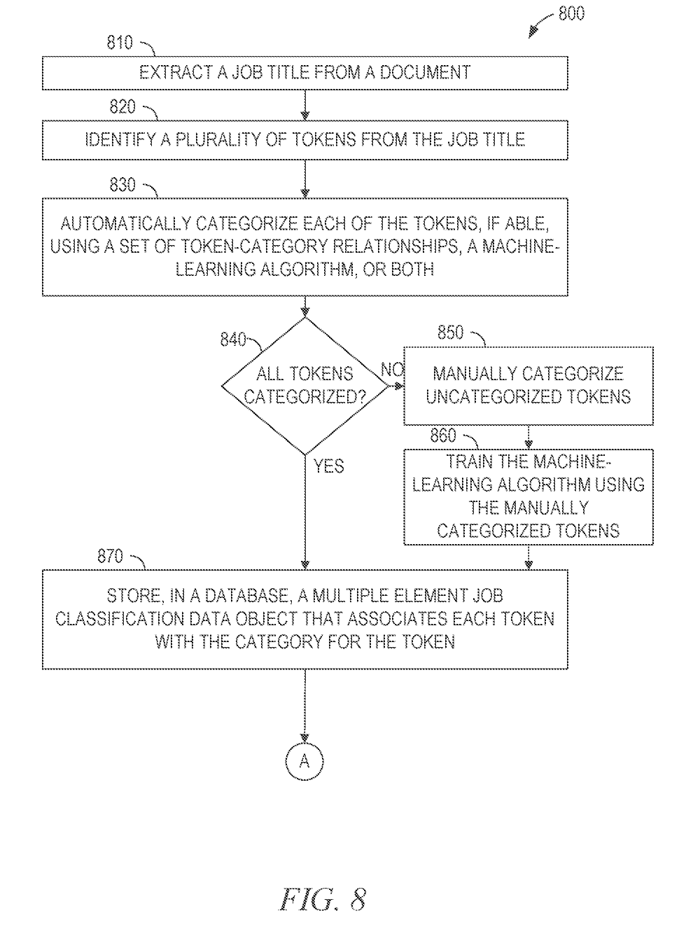

FIGS. 8-9 are a flowchart illustrating operations of a method 800 suitable for training a machine-learning algorithm, storing multiple element job classification data objects in a database, and causing presentation of job listings in response to a search query, according to some example embodiments. The method 800 includes operations 810, 820, 830, 840, 850, 860, 870, 910, 920, 930, 940, 950, 960, 970, and 980. By way of example and not limitation, the method 800 is described as being performed by the devices, modules, and databases of FIGS. 1-3.

The scraping module 220 extracts a job title from a document, in operation 810. For example, the scraping module 220 may periodically access web sites of a predefined list of web sites stored in the scraping table 310. After retrieving a copy of the web site, the scraping module 220 parses the web site to identify job listings (e.g., job listings that include job titles). As another example, an administrator may provide a document containing a set of job titles selected for the purpose of training a machine-learning algorithm.

In operation 820, the tokenizer module 240 identities a plurality of tokens from the job title. The classification module 230, in operation 830, categorizes the tokens of the job title using a set of token-category relationships, a machine-learning algorithm, or both. For example, the SQL query “SELECT Category FROM TokenCategorizationTable WHERE Token=TitleToken” may be executed for each identified token. Each query will return zero, one, or more than one category. If exactly one category is returned, the returned category may be used for the token. If zero or multiple categories are returned, the token and the job title may be provided as inputs to a machine-learning algorithm that provides a probability of the token belonging to one or more categories. If the probability of the token belonging to a particular category exceeds a predetermined threshold (e.g., 80%), the particular category may be used for the token.

The classification nodule 230, in operation 840, determines if all tokens have been categorized. If so, the method 800 continues with operation 870. Otherwise, the classification module 230 manually categorizes the uncategorized tokens in operation 850. For example, a user interface may be presented on the client device 130A via the web interface 140 using a web page supplied by the search server 110. In some example embodiments, the user interface includes a drop-down selector that allows the user to select a category for the token. The highest probability category for the token identified by the machine-learning algorithm in operation 830 may be provided as a suggested category. The category selected by the user is used as the category for the token.

In operation 860, the machine-learning algorithm of the classification module 230 is trained using the manually categorized tokens. Additionally, the association between each manually categorized token and its assigned category may be stored for later use (e.g., in the token categorization table 360).

The storage module 260 stores, in a database, a multiple element job classification data object that associates each token with the category for the token (operation 870). For example, a row may be added to the multiple element job classification table 335. Operations 810-870 may be repeated for multiple job listings and multiple documents to populate the multiple element job classification table 335 and train the machine-learning algorithm.

The tokenizer module 240 accesses, in operation 910, a search query. In operation 920, the tokenizer module 240 identifies a plurality of tokens from the search query. The classification module 230 automatically categorizes each of the tokens, if able, using a set of token-category relationships, a machine-learning algorithm, or both (operation 930).

The classification module 230, in operation 940, determines if all tokens have been categorized. If so, the method 800 continues with operation 970. Otherwise, the classification module 230 manually categorizes the uncategorized tokens in operation 950 (e.g., following the same process as described for operation 850 above). In operation 960, the machine-learning algorithm of the classification module 230 is trained using the manually categorized tokens. Additionally, the association between each manually categorized token and its assigned category may be stored for later use (e.g., in the token categorization table 360).

In operation 970, the search module 250 selects, from the database, a set of multiple job classification data objects, each selected multiple classification data object having a token that matches a token of the search query, the matching tokens being members of the same category, each selected multiple job classification data object representing a responsive job listing. For example, a SQL query such as “SELECT*from MultipleElementJobClassification WHERE raw_title=first.raw_title OR jobs=first.jobs OR skills=first.skills OR experience=first.experience” may be run against the multiple element job classification table 335 to identify rows in the table that match the search query in the raw title, jobs, skills, or experience categories.

The search module 250 causes presentation of at least a portion of the set of responsive multiple element job classification data objects (operation 980). For example, a web page including a list of the raw title fields of the first ten responsive multiple element job classification data objects may be presented to the user via the web interface 140 of the client device 130A.

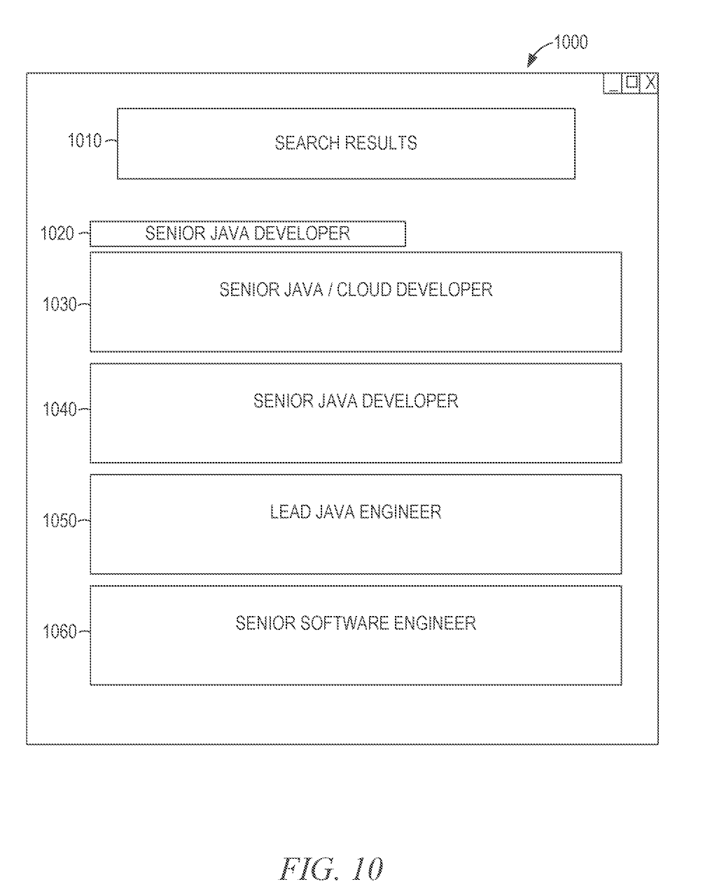

FIG. 10 is a screen diagram illustrating a user interface 1000 suitable for presenting search results, according to some example embodiments. As can be seen in the screen diagram, the user interface 1000 includes a title 1010, “Search Results,” a search query 1020, and four search results 1030, 1040, 1050, and 1060. The user interface 1000 is suitable for display in operation 730 of the method 700 or operation 980 of the method 800.

The user interface 1000 may be displayed in response to a user query. For example, if the user enters a query for “senior java developer” on a client device 130, the query may be transmitted from the client device 130 to the search server 110. The search server 110 identifies categories for tokens of the query using the method 400 or the method 500 and generates a multiple element job classification data object that corresponds to the query. The search results 1030-1060 are selected by the search server 110 from the job database 180 and displayed in the user interface 1000.

Each search result 1030-1060 may be operable to view additional information about the search result. For example, clicking on or otherwise activating a search result may result in a new page being displayed that shows additional information about the job listing, such as a job description, location, salary, and so on,

### EXAMPLES

### Example 1

A system comprising:
a memory that stores instructions; and
one or more processors configured by the instructions to perform operations comprising:
   receiving a search query including a string identifying a job title;
   determining, based on the string, a plurality of tokens;
   for each token of the plurality of tokens:
      in the event of the token not corresponding to any category of a plurality of categories:
         determining, for the token, a probability of being a member of each of the plurality of categories; and
         based on the determined probability of the token being a member of each of the plurality of categories, selecting a proposed category for the token;
   selecting a set of job listings, from a database containing data representing a plurality of job listings, each job listing of the set of job listings comprising a token that matches a token of the search query, the matching tokens being members of a same category; and
   causing presentation of a user interface that includes at least a portion of the selected set of job listings.

### Example 2

The system of example 1, wherein:
the determining, for each token of the plurality of tokens, the probability of being a member of each of the plurality of categories is performed by a machine-learning algorithm; and
the operations further comprise:
   automatically accessing a document;
   parsing the document to identify a job listing that includes a title;
   determining, based on the title, a plurality of title tokens;
   determining a category for each title token;
   training the machine-learning algorithm using the determined category for each title token; and
   storing, in the database, data representing the job listing, the data comprising the title tokens, each title token being stored as a member of the determined category for the title token.

### Example 3

The system of example 2, wherein:
the determining, for each token of the plurality of tokens, the probability of being a member of each of the plurality of categories is performed by a machine-learning algorithm; and
the operations further comprise:
   in the event of the token not corresponding to any category of the plurality of categories:
      causing presentation of a user interface comprising the token and the proposed category;
      detecting a user input that selects a category for the token; and
      training the machine-learning algorithm using the selected category for the token.

### Example 4

The system of examples 2 to 3, wherein the accessing of the document comprises accessing the document based on a uniform resource locator (URL).

### Example 5

The system of examples 2 to 4, wherein the determining of the category for each title token comprises:
in the event of the title token not corresponding to any category of the plurality of categories:
   determining, for the title token, a probability of being a member of each of the plurality of categories; and
   based on the determined probability of the title token being a member of each of the plurality of categories, selecting a proposed category for the token.

### Example 6

The system of example 5, wherein the operations further comprise, in the event of the title token not corresponding to any category of the plurality of categories:
causing presentation of a user interface comprising the title token and the proposed category; and
detecting a user input that confirms the proposed category for the title token.

### Example 7

The system of example 5, wherein, in the event of the title token not corresponding to any category of the plurality of categories:
the operations further comprise:
   causing presentation of a user interface comprising the title token and the proposed category and
   detecting a user input that selects the proposed category or an alternative category for the token; and
the storing of the data representing the job listing comprises storing the title token as a member of the selected category.

### Example 8

The system of examples 1 to 7, wherein the selecting of the set of job listings from the plurality of job listings is based on a match between the token corresponding to each category and the token for the category for the job listing.

### Example 9

The system of examples 1 to 8, wherein:
the operations further comprise normalizing the string; and
the determining, based on the string, of the plurality of tokens comprises determining, based on the normalized string, the plurality of tokens.

### Example 10

The system of example 9, wherein the normalizing of the string comprises converting uppercase letters in the string to lowercase letters.

### Example 11

The system of examples 9 to 10, wherein the normalizing of the string comprises removing punctuation from the string.

### Example 12

The system of examples 1 to 11, wherein, in the event of the token not corresponding to any category of the plurality of categories, the selecting of the proposed category for the token comprises selecting a category with a highest probability of the token being a member of the category among the probabilities of the token being a member of each of the plurality of categories.

### Example 13

The system of examples 1 to 12, wherein the plurality of categories comprises a language category, a job category, a skill category, and an experience category.

### Example 14

A method comprising:
receiving, by one or more processors, a search query including a string identifying a job title;
determining, by the one or more processors, a plurality of tokens based on the string;
for each token of the plurality of tokens:
   in the event of the token not corresponding to any category of a plurality of categories:
      determining, for the token, a probability of being a member of each of the plurality of categories; and
      based on the determined probability of the token being a member of each of the plurality of categories, selecting a proposed category for the token;
selecting, by the one or more processors, from a database containing data representing a plurality of job listings, each job listing of the set of job listings comprising a token that matches a token of the search query, the matching tokens being members of a same category; and
causing presentation of a user interface that includes at least a portion of the selected set of job listings.

### Example 15

The method of example 14, wherein:
the determining, for each token of the plurality of tokens, the probability of being a member of each of the plurality of categories is performed by a machine-learning algorithm; and
further comprising:
   automatically accessing a document;
   parsing the document to identify a job listing that includes a title;
   determining, based on the title, a plurality of title tokens;
   determining a category for each title token;
   training the machine-learning algorithm using the determined category for each title token; and
   storing, in the database, data representing the job listing, the data comprising the title tokens, each title token being stored as a member of the determined category for the title token.

### Example 16

The method of example 15, wherein:
the determining, for each token of the plurality of tokens, the probability of being a member of each of the plurality of categories is performed by a machine-learning algorithm; and
further comprising:
   in the event of the token not corresponding to any category of the plurality of categories:
      causing presentation of a user interface comprising the token and the proposed category;
      detecting a user input that selects a category for the token; and
      training the machine-learning algorithm using the selected category for the token.

### Example 17

The method of example 15, wherein the determining of the category for each title token comprises:
in the event of the title token not corresponding to any category of the plurality of categories:
   determining, for the title token, a probability of being a member of each of the plurality of categories; and
   based on the determined probability of the title token being a member of each of the plurality of categories, selecting a proposed category for the token.

### Example 18

The method of example 17, wherein the operations further comprise, in the event of the title token not corresponding to any category of the plurality of categories:
causing presentation of a user interface comprising the title token and the proposed category; and
detecting a user input, that confirms the proposed category for the tide token.

### Example 19

The method of example 17, wherein, in the event of the title token not corresponding to any category of the plurality of categories:
the operations further comprise:
   causing presentation of a user interface comprising the title token and the proposed category; and
   detecting a user input that selects the proposed category or an alternative category for the token; and
the storing of the data representing the job listing comprises storing the title token as a member of the selected category.

### Example 20

A non-transitory machine-readable storage medium comprising instructions that, when executed by one or more processors of a machine, cause the machine to perform operations comprising:
receiving a search query including a string identifying a job title;
determining, based on the string, a plurality of tokens;
for each token of the plurality of tokens:
   in the event of the token not corresponding to any category of a plurality of categories:
      determining, for the token, a probability of being a member of each of the plurality of categories; and
      based on the determined probability of the token being a member of each of the plurality of categories, selecting a proposed category for the token;
selecting a set of job listings, from a database containing data representing a plurality of job listings, each job listing of the set of job listings comprising a token that matches a token of the search query, the matching tokens being members of a same category; and
causing presentation of a user interface that includes at least a portion of the selected set of job listings.

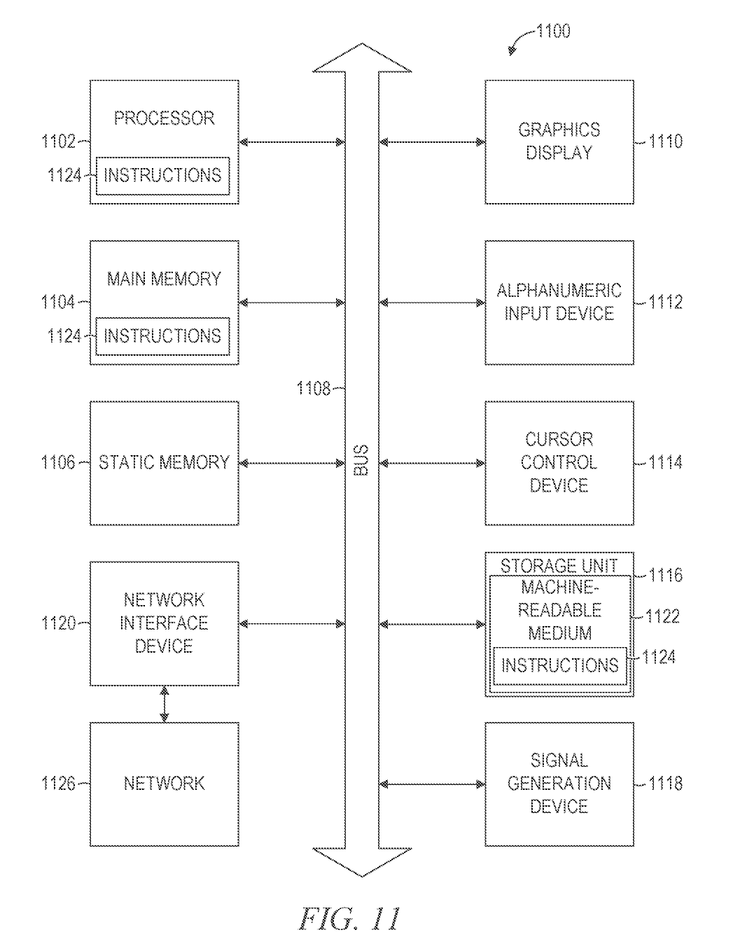

FIG. 11 is a block diagram illustrating components of a machine 1100, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 11 shows a diagrammatic representation of the machine 1100 in the example form of a computer system within which instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light-emitting diode (LED) display, a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or another pointing instrument), a storage unit 1116, a signal generation device 1118 (e.g., a speaker), and a network interface device 1120.

The storage unit 1116 includes a machine-readable medium 1122 on which are stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown, in an example embodiment, to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., the machine 1100), such that the instructions, when executed by one or more processors of the machine (e.g., the processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments art described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module ma be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may he performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors configured by the instructions to perform operations comprising:
receiving a search query including a string identifying a job title;
determining, based on the string, a plurality of tokens;
for each token of the plurality of tokens:
in the event of the token not corresponding to any category of a plurality of categories:
determining, for the token, a probability of being a member of each of the plurality of categories; and
based on the determined probability of the token being a member of each of the plurality of categories, selecting a proposed category for the token;
selecting a set of job listings, from a database containing data representing a plurality of job listings, each job listing of the set of job listings comprising a token that matches a token of the search query, the matching tokens being members of a same category; and
causing presentation of a user interface that includes at least a portion of the selected set of job listings.

2. The system of claim 1, wherein:
the determining, for each token of the plurality of tokens, the probability of being a member of each of the plurality of categories is performed by a machine-learning algorithm; and
the operations further comprise:
automatically accessing a document;
parsing the document to identify a job listing that includes a title;
determining, based on the title, a plurality of title tokens;
determining a category for each title token;
training the machine-learning algorithm using the determined category for each title token; and
storing, in the database, data representing the job listing, the data comprising the title tokens, each title token being stored as a member of the determined category for the title token.

3. The system of claim 2, wherein:
the determining, for each token of the plurality of tokens, the probability of being a member of each of the plurality of categories is performed by a machine-learning algorithm; and
the operations further comprise:
in the event of the token not corresponding to any category of the plurality of categories:
causing presentation of a user interface comprising the token and the proposed category;
detecting a user input that selects a category for the token; and
training the machine-learning algorithm using the selected category for the token.

4. The system of claim 2, wherein the accessing of the document comprises accessing the document based on a uniform resource locator (URL).

5. The system of claim 2, wherein the determining of the category for each title token comprises:
in the event of the title token not corresponding to any category of the plurality of categories:
determining, for the title token, a probability of being a member of each of the plurality of categories; and
based on the determined probability of the title token being a member of each of the plurality of categories, selecting a proposed category for the token.

6. The system of claim 5, wherein the operations further comprise, in the event of the title token not corresponding to any category of the plurality of categories:
causing presentation of a user interface comprising the title token and the proposed category; and
detecting a user input that confirms the proposed category for the title token.

7. The system of claim 5, wherein, in the event of the title token not corresponding to any category of the plurality of categories:
the operations further comprise:
causing presentation of a user interface comprising the title token and the proposed category; and
detecting a user input that selects the proposed category or an alternative category for the token; and
the storing of the data representing the job listing comprises storing the title token as a member of the selected category.

8. The system of claim 1, wherein the selecting of the set of job listings from the plurality of job listings is based on a match between the token corresponding to each category and the token for the category for the job listing.

9. The system of claim 1, wherein:
the operations further comprise normalizing the string; and
the determining, based on the string, of the plurality of tokens comprises determining, based on the normalized string, the plurality of tokens.

10. The system of claim 9, wherein the normalizing of the string comprises converting uppercase letters in the string to lowercase letters.

11. The system of claim 9, wherein the normalizing of the string comprises removing punctuation from the string.

12. The system of claim 1, wherein, in the event of the token not corresponding to any category of the plurality of categories, the selecting of the proposed category for the token comprises selecting a category with a highest probability of the token being a member of the category among the probabilities of the token being a member of each of the plurality of categories.

13. The system of claim 1, wherein the plurality of categories comprises a language category, a job category, a skill category, and an experience category.

14. A method comprising:
receiving, by one or more processors, a search query including a string identifying a job title;
determining, by the one or more processors, a plurality of tokens based on the string;
for each token of the plurality of tokens:
in the event of the token not corresponding to any category of a plurality of categories:
determining, for the token, a probability of being a member of each of the plurality of categories; and
based on the determined probability of the token being a member of each of the plurality of categories, selecting a proposed category for the token;
selecting, by the one or more processors, from a database containing data representing a plurality of job listings, each job listing of the set of job listings comprising a token that matches a token of the search query, the matching tokens being members of a same category; and
causing presentation of a user interface that includes at least a portion of the selected set of job listings.

15. The method of claim 14, wherein:
the determining, for each token of the plurality of tokens, the probability of being a member of each of the plurality of categories is performed by a machine-learning algorithm; and
further comprising:
automatically accessing a document;
parsing the document to identify a job listing that includes a title;
determining, based on the title, a plurality of title tokens;
determining a category for each title token;
training the machine-learning algorithm using the determined category for each title token; and
storing, in the database, data representing the job listing, the data comprising the title tokens, each title token being stored as a member of the determined category for the title token.

16. The method of claim 15, wherein:
the determining, for each token of the plurality of tokens, the probability of being a member of each of the plurality of categories is performed by a machine-learning algorithm; and
further comprising:
in the event of the token not corresponding to any category of the plurality of categories:
causing presentation of a user interface comprising the token and the proposed category;
detecting a user input that selects a category for the token; and
training the machine-learning algorithm using the selected category for the token.

17. The method of claim 15, wherein the determining of the category for each title token comprises:
in the event of the title token not corresponding to any category of the plurality of categories:
determining, for the title token, a probability of being a member of each of the plurality of categories; and
based on the determined probability of the title token being a member of each of the plurality of categories, selecting a proposed category for the token.

18. The method of claim 17, wherein the operations further comprise, in the event of the title token not corresponding to any category of the plurality of categories:
causing presentation of a user interface comprising the title token and the proposed category; and
detecting a user input, that confirms the proposed category for the tide token.

19. The method of claim 17, wherein, in the event of the title token not corresponding to any category of the plurality of categories:
the operations further comprise:
causing presentation of a user interface comprising the title token and the proposed category; and
detecting a user input that selects the proposed category or an alternative category for the token; and
the storing of the data representing the job listing comprises storing the title token as a member of the selected category.

20. A non-transitory machine-readable storage medium comprising instructions that, when executed by one or more processors of a machine, cause the machine to perform operations comprising:
receiving a search query including a string identifying a job title;
determining, based on the string, a plurality of tokens;
for each token of the plurality of tokens:
in the event of the token not corresponding to an category of a plurality of categories:
determining, for the token, a probability of being a member of each of the plurality of categories; and
based on the determined probability of the token being a member of each of the plurality of categories, selecting a proposed category for the token;
selecting a set of job listings, from a database containing data representing a plurality of job listings, each job listing of the set of job listings comprising a token that matches a token of the search query, the matching tokens being members of a same category; and
causing presentation of a user interface that includes at least a portion of the selected set of job listings.
